(19) United States
(12) Patent Application Publication
(10) Pub. No.: US 2014/0379395 A1
(43) Pub. Date: Dec. 25, 2014

(54) STATE-BASED DECENTRALIZED HARDWARE ASSET MANAGEMENT

(71) Applicant: Microsoft Corporation, Redmond, WA (US)

(72) Inventors: Sriram Sankar, Redmond, WA (US); Badriddine Khessib, Redmond, WA (US)

(21) Appl. No.: 13/922,236

(22) Filed: Jun. 19, 2013

(51) Int. Cl. G06Q 10/06

(52) U.S. Cl. CPC G06Q 10/0631
USPC 705/7.12

(57) ABSTRACT

State-based decentralized hardware asset management comprises managed assets and a manager, both of which comprise information about the other. If a managed asset is replaced, communications are exchanged between the manager and the replacement asset so that each can obtain identifying information about the other. If the asset manager is replaced, initially, the replacement asset manager can broadcast a request for identifying information to the assets it is managing. Additionally, periodic communications between the assets and the manager request, from each asset, identifying information of the manager. To ensure that each asset recognizes the replacement asset manager, a voting process is utilized. An asset manager also maintains state information for each asset informing subsequent action to be undertaken by the asset manager with respect to each such asset and enabling the asset manager to optimze its operation, including by avoiding actions and communications incompatible with current asset states.

### BACKGROUND

The ever increasing availability of high throughput computer network connections has enabled computer processing capability to be distributed among many different computing devices that can be spread out across a variety of physical locations. For example, data centers, housing hundreds or thousands of computing devices, are becoming more commonplace, both among entities that seek to utilize for themselves the processing capabilities supported by such datacenters, and by entities that seek to sell such processing capabilities to others. Irrespective of the manner in which data centers are monetized, each data center, and the computing devices and associated hardware contained therein, can represent a substantial financial investment. More specifically, much of the hardware that comprises a data center, especially the computational hardware, can, not only, require an initial outlay of capital to purchase such hardware, but can also represent a depreciating asset whose value decreases over time.

Consequently, it can be financially beneficial to track hardware to ensure that it is being utilized in an efficient manner. It can also be financially beneficial to track hardware for purposes of improving future estimates of capital expenditures and other like financial investments in such hardware resources. Unfortunately, tracking and managing a myriad of hardware across diverse geographic locations can be difficult to implement. For example, a single data center can comprise thousands of computing devices and associated hardware that can need to be individually tracked and managed. Many organizations, however, can manage multiple data centers that can be spread across diverse geographic locations, exponentially increasing the amount of hardware to be tracked.

Traditional mechanisms for tracking and managing hardware, especially large volumes of physically distributed hardware, comprise centralized mechanisms that aggregate the relevant information into a single centralized database. Such mechanisms can be inefficient, as there can be communicational delays in communicating with centralized mechanisms that may be located in a location geographically distant from the location of the hardware being managed. Additionally, such mechanisms can be inefficient due to the cost of implementing and maintaining the hardware needed to implement such centralized mechanisms in the first place.

### SUMMARY

In one embodiment, hardware asset management can comprise a manager managing a defined set of managed assets, where both the manager and the managed assets can comprise information about one another. The manager can maintain information regarding the managed assets including detailed identification information. Additionally, the managed assets can maintain identification information, and, optionally, additional information, regarding the manager that is managing them.

In another embodiment, if one of the managed assets is replaced, such as due to an upgrade, or a replacement of a failed asset, communications can be exchanged between the manager and the replacement managed asset so that the manager can obtain identifying information, and, optionally, other detailed information, about the replacement managed asset, and so that the replacement managed asset can obtain an identification, and, optionally, other detailed information, about the manager.

In a further embodiment, if the asset manager is replaced, such as due to an upgrade, or a replacement of a failed asset manager, initially, the replacement asset manager can broadcast a request for identifying information, and, optionally, other detailed information, to the assets it is managing. Additionally, periodic communications between the assets being managed and the asset manager can include a request, by each of the assets, individually, for identifying information, and, optionally, other detailed information, about the replacement asset manager. To ensure that each asset it is managing recognizes the replacement asset manager, the replacement asset manager can request, of the assets, an identification of the asset manager that those assets believe is their asset manager. If such an identification does not match that of the asset manager initiating such a request, corrective action can be performed.

In a still further embodiment, an asset manager can maintain state information for each asset it is managing, the state information indicating a state that the asset is in, and informing a subsequent action to be undertaken by the asset manager with respect to each such asset. The asset manager can establish appropriate states given the asset being managed, such that simple assets can comprise only two or three states, such as a “power on” or “power off” state, or a further subdivision of the “power on” state into an “operational” state and a “failed” state. More complex assets can be associated with additional, more detailed, intermediate states. Periodic communications between the asset manager and the assets being managed can enable the asset manager to update the state information for individual assets it is managing and inform the next periodic communication.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Additional features and advantages will be made apparent from the following detailed description that proceeds with reference to the accompanying drawings.

### DESCRIPTION OF THE DRAWINGS

The following detailed description may be best understood when taken in conjunction with the accompanying drawings, of which:

FIG. 1 is a block diagram illustrating an exemplary system implementing an exemplary decentralized hardware asset management;

FIG. 2 is a block diagram illustrating an exemplary system implementing an alternative exemplary decentralized hardware asset management;

FIG. 3 is a flow diagram of an exemplary operation of decentralized hardware asset management;

FIG. 4 is a state diagram of an exemplary sequence of states of an asset being managed by decentralized hardware asset management; and

FIG. 5 is a block diagram of an exemplary computing device.

### DETAILED DESCRIPTION

The following description relates to state-based decentralized hardware asset management comprising both managed assets and a manager managing those assets. Both the manager and the managed assets can comprise information about one another. If one of the managed assets is replaced, communications can be exchanged between the manager and the replacement managed asset so that the manager can obtain identifying information, and, optionally, other detailed information, about the replacement managed asset, and so that the replacement managed asset can obtain an identification, and, optionally, other detailed information, about the manager. If the asset manager is replaced, initially, the replacement asset manager can broadcast a request for identifying information, and, optionally, other detailed information, to the assets it is managing. Additionally, periodic communications between the assets being managed and the asset manager can include a request, by each of the assets, individually, for identifying information, and, optionally, other detailed information, about the replacement asset manager. To ensure that each asset recognizes the replacement asset manager, the replacement asset manager can request, of the assets, an identification of the asset manager that those assets believe is their asset manager. An asset manager can also maintain state information for each asset it is managing, the state information indicating a state that the asset is in, and informing a subsequent action to be undertaken by the asset manager with respect to each such asset. The state information also enables an asset manager to optimize performance, such as by avoiding the monitoring or attempted performance of actions that are incompatible with a current state of an asset.

For purposes of illustration, the techniques described herein are directed to specific types of hardware, such as rack-mount server computing devices. However, references to, and illustrations of, such hardware are strictly exemplary and are not intended to limit the mechanisms described to the specific examples provided. Indeed, the techniques described are applicable to any hardware asset that is individually purchasable and replaceable.

Additionally, although not required, the description below will be in the general context of computer-executable instructions, such as program modules, being executed by one or more computing devices. More specifically, the description will reference acts and symbolic representations of operations that are performed by one or more computing devices or peripherals, unless indicated otherwise. As such, it will be understood that such acts and operations, which are at times referred to as being computer-executed, include the manipulation by a processing unit of electrical signals representing data in a structured form. This manipulation transforms the data or maintains it at locations in memory, which reconfigures or otherwise alters the operation of the computing device or peripherals in a manner well understood by those skilled in the art. The data structures where data is maintained are physical locations that have particular properties defined by the format of the data.

Generally, program modules include routines, programs, objects, components, data structures, and the like that perform particular tasks or implement particular abstract data types. Moreover, those skilled in the art will appreciate that the computing devices need not be limited to conventional personal computers, and include other computing configurations, including hand-held devices, multi-processor systems, microprocessor based or programmable consumer electronics, network PCs, minicomputers, mainframe computers, and the like. Similarly, the computing devices need not be limited to a stand-alone computing device, as the mechanisms may also be practiced in distributed computing environments linked through a communications network. In a distributed computing environment, program modules may be located in both local and remote memory storage devices.

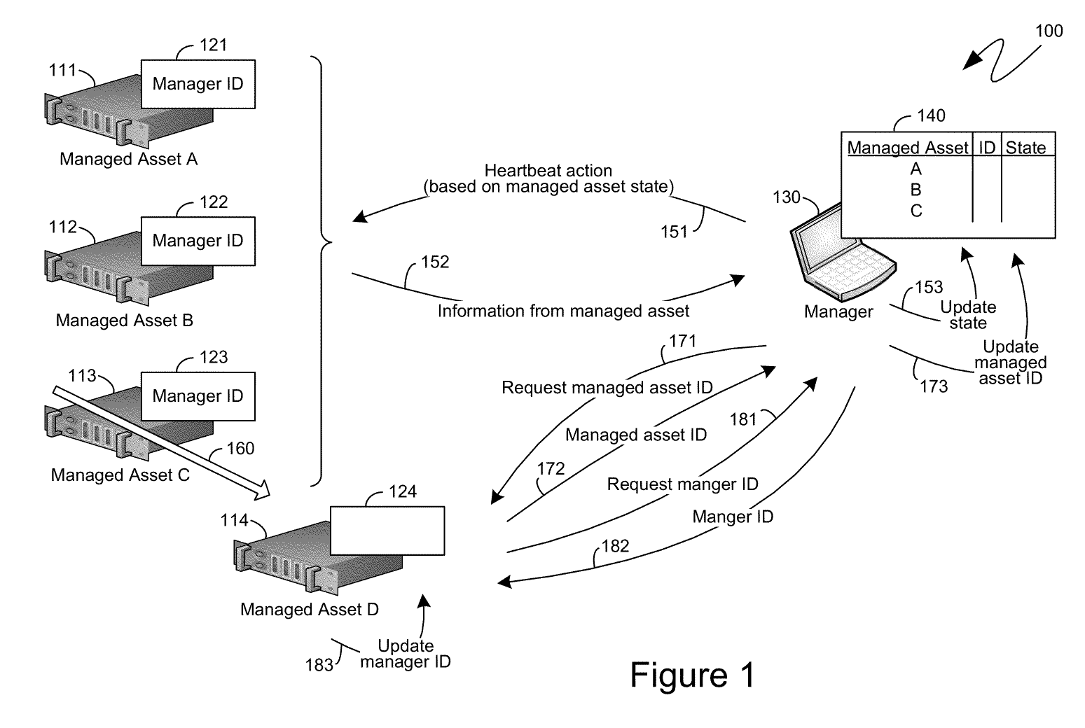

With reference to FIG. 1, an exemplary system 100 is illustrated, providing context for the descriptions below. The exemplary system 100 is illustrated as comprising managed assets in the form of managed assets 111, 112, 113 and 114, and a manager, in the form of manager 130. As utilized herein, the term “manager” will mean a managing device comprising the capability to transmit and receive the manager communications described below and to perform the manager actions described below. Additionally, as utilized herein, the term “asset” or “managed asset” will mean a device comprising the capability to transmit and receive the asset communications described below and to perform the asset actions described below As indicated previously, while the managed assets 111, 112, 113 and 114 are illustrated in the form of server blade computing devices, other managed assets can equally be utilized in accordance with, and can perform, the functions and mechanisms described in detail below. For example, managed assets can include power supplies, fans, support infrastructure, or other like assets that can be individually replaced, and which it is desirable to track and manage. Similarly, the manager 130 is illustrated in the form of a laptop computing device merely to graphically signify that the manager 130 need not execute on a computing device that comprises processing capabilities equivalent to those of some of the managed assets. Instead, in one embodiment, the manager 130 can be a low-power, inexpensive computing device with reduced processing functionality, such as compared to some of the managed assets, that can be installed proximate to, or otherwise co-located with, some or all of the managed assets it is managing.

In one embodiment, the manager 130 can comprise an asset management table 140 that can comprise information about the assets that the manager 130 is managing. For example, the asset management table 140 can comprise a unique identifier for each of the managed assets 111, 112 and 113 that the manager 130 can be managing at a point in time. Additionally, in one embodiment, the asset management table 140 can comprise further information, such as further identifying information, or other further asset tracking and utilization information. For example, the asset management table 140 can comprise information indicative of the manufacturer of an asset, the model number of an asset, the date of manufacture of an asset, the version number of an asset, any asset options that may be installed or set on an asset, and other like information. As will be recognized by those skilled in the art, such additional information is often colloquially referred to as Field Replaceable Unit information, or FRU information.

The management of the assets 111, 112 and 113, by the manager 130, can, in one embodiment, include periodic communications from the manager 130 to the assets 111, 112 and 113. Such periodic communications can include instructions that the manager 130 desires the managed assets 111, 112 and 113 to carry out, as well as status checks or verifications that the manager 130 seeks to perform. In response to such periodic communications, the manager 130 can receive information from the managed assets 111, 112 and 113, including, for example, confirmation that an instruction was carried out, information obtained by the carrying out of the instruction, status information, or other like information.

In one embodiment, as will be described in further detail below, the manager 130 can also maintain information regarding a state of one or more of the assets it is managing such as, for example, the managed assets 111, 112 and 113 shown in the system 100 of FIG. 1. Such state information can be retained, by the manager 130, in the asset management table 140, and can be updated in accordance with information received from the managed assets in response to the periodic communications. Additionally, such state information can inform the next periodic communication made by the manager 130 to each asset. In the system 100 of FIG. 1, periodic communications from the manager 130 are illustrated in the form of a “heartbeat” communication 151. As indicated, such a “heartbeat” communication 151 can be in accordance with a state of the asset to which such a communication is directed, as currently perceived by the manager 130, and as currently stored in the asset management table 140. Additionally, because the manager 130 can maintain state information, it can optimize its performance based on such information. For example, if the manager 130 is aware that a managed asset is in a transitory state in which the asset cannot respond to communications from the manager 130, the manager 130 can avoid sending such communications for a defined period of time. As another example, the heartbeat communications, such as the exemplary heartbeat communication 151, can include the checking of various aspects of the operation of a managed asset. In such an example, the manager 130 can avoid sending those heartbeat communications to assets whose state is incompatible with that kind of checking.

A response to the communication 151, can be provided individually, by one or more of the managed assets 111, 112 and 113. Such a response is illustrated in FIG. 1 as responsive communication 152. Upon receiving the communication 152, the manager 130 can update the asset management table 140, such as is illustrated by the action 153. Such periodic, “heartbeat” communicational exchanges can continue between the manager 130 and the managed assets 111, 112 and 113 so long as the manager 130 is still assigned to manage the managed assets 111, 112 and 113.

In some instances, however, it can be advantageous to replace an asset that is being managed by the manager 130, or to assign new assets to be managed by the manager 130. For example, in the exemplary system 100 of FIG. 1, the asset 113 is illustrated as being replaced, such as by the replacement action 160, by a new asset 114. Upon completion of such a replacement 160, the manager 130 can, in one embodiment, direct communications to the new asset 114, requesting an identifier or other identifying information, such as is illustrated by the communication 171. In response, the new asset 114 can return, as indicated by the communication 172, its identifier or other identifying information, such as the aforementioned FRU information. Upon receiving such information, the manager 130 can update the asset management table 140 to now include the new asset 114, and its associated information that was received via the communication 172. In one embodiment, the asset manager 130 can also detect the removal of the asset 113, as part of the replacement action 160, and can actively delete information associated with the asset 113 from the asset management table 140. In another embodiment, the asset management table 140 can comprise a time-based sequence of entries logging the information described above over a defined period of time. In such an embodiment, the most recent entries can comprise a current state of the asset management table 140, but prior entries can also be available, such as for time-based analysis. In such an embodiment, the manager 130 need not actively remove information regarding the managed asset 113, even after the manager 130 is no longer managing such an asset, since the mere absence of information regarding such an asset in the asset management table 140 subsequent to a time when the asset 113 was removed can be sufficient to indicate that it is no longer being managed by the manager 130.

To provide decentralized hardware asset management, in one embodiment, the assets being managed can comprise an identification of the manager managing them, or, more specifically, of the manager they believe is currently managing them. Thus, for example, as illustrated in the exemplary system 100 of FIG. 1, the assets 111, 112 and 113 can comprise tables 121, 122 and 123, respectively, that can comprise at least an identification of the manager 130. Such tables, identification information, can be retained by managed assets in dedicated computer-readable memory, such as, for example, a dedicated EEPROM or other like computer-readable memory that can be sufficiently inexpensive to include even in simple assets such as, for example, fans, power supplies, and other like hardware.

When a new managed asset, such as the asset 114, is added to the assets that are being managed by the manager 130, such as by replacing an existing asset 113, as illustrated by the replacement action 160, the new asset 114 can comprise a table 124 that can lack an identification of the manager 130, since the asset 114 would not be aware that the manager 130 was managing it. Consequently, in one embodiment, the manager 130 can request that the asset 114 provide it with an identification of the manager that the asset 114 believes is currently managing it. In an alternative embodiment, illustrated in the system 100 of FIG. 1, assets can periodically request identification information, or, optionally, further information, from the manager managing those assets. Thus, for example, when the new asset 114 is added to the system 100, in addition to providing its information to the manager 130, such as in response to a specific request from the manager 130, as detailed above, the asset 114 can also issue request 181, to the manager 130, requesting information from the manager 130. In one embodiment, as indicated, the communication 181 can be a periodic communication that need not be triggered by any event other than the passage of time. In an alternative embodiment, the communication 181 can be triggered by the asset 114 receiving the communication 171 from a manager, namely the manager 130, that differs from the manager that the asset 114 believes is currently managing it, such as could be stored in the table 124. Irrespective of the triggering mechanisms, in response to the communication 181, the requested information can be provided by the manager 130, such as via the communication 182. The asset 114 can then update the table 124 with the identifying information provided in the communication 182, as illustrated by the action 183.

In one embodiment, the updating, by an asset, of its locally-maintained table comprising identification of the manager which that asset believes is managing it can occur as part of a voting process among the assets. Such a voting process will be described in further detail below. In another embodiment, however, under certain circumstances, assets can update their locally-maintained manager identifiers on their own and without external support. For example, assets whose tables are blank, or otherwise indicate that the asset either was just installed or was not previously managed, can initialize such a table with whichever manager identifier such an asset first receives. Thus, as illustrated by the action 183 in FIG. 1, the asset 114 can update the table 124 with the manager identifier received via communication 182 without referencing any of the other assets 111, 112 or 113, or without explicit instruction from the manager 130 because, in the scenario illustrated by the system 100 of FIG. 1, the asset 114 does not have any earlier manager information in the table 124.

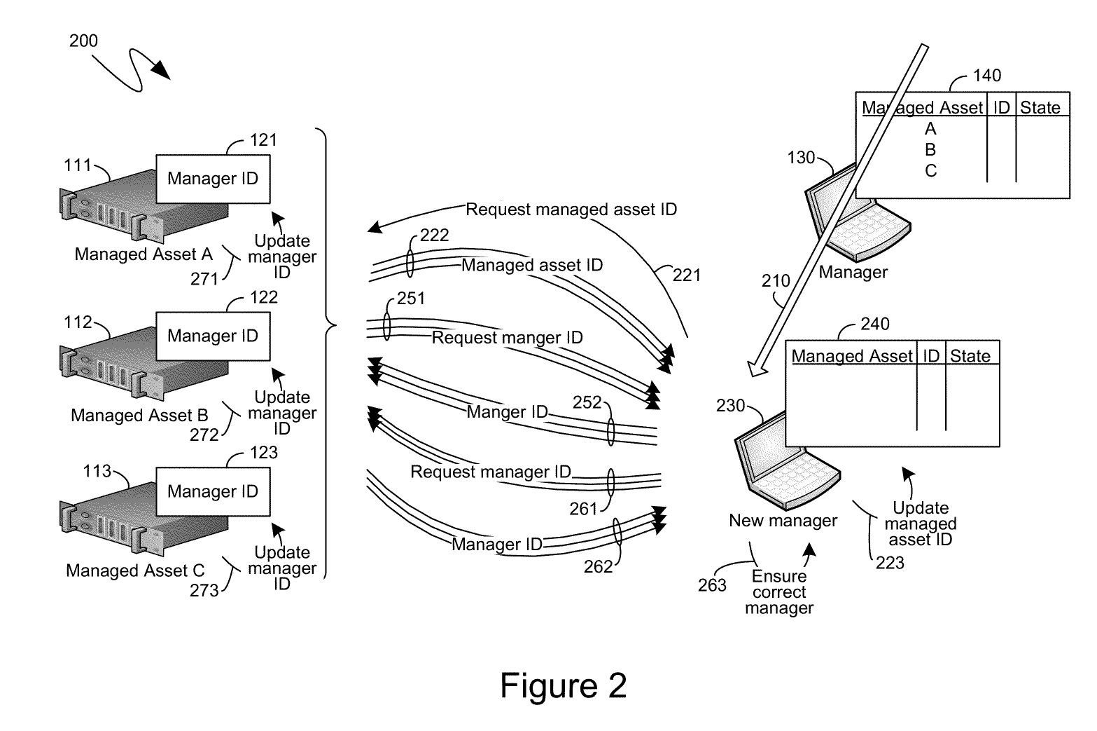

Turning to FIG. 2, the system 200 shown therein illustrates an exemplary series of communications that can be exchanged when it is the manager 130 that is replaced. More specifically, the manager 130 can be replaced, as illustrated by the replacement action 210 in FIG. 2, with a new manager 230. The new manager 230 can comprise an asset management table 240 that can, at least initially, be blank, or which can comprise outdated information, or information otherwise inapplicable to the assets that the new manager 230 is now managing, namely the assets 111, 112 and 113. Thus, in one embodiment, a new manager, such as the new manager 230, can broadcast a request 221 to each of the assets 111, 112 and 113, requesting identification information, and, optionally, additional information, from each of those assets. In response, the assets can provide, individually, the information requested, as illustrated by the communications 222. Upon receiving such information, individually, from each of the assets it is managing, such as the assets 111, 112 and 113, the new manager 230 can update its asset management table 240, as illustrated by the action 223.

Additionally, as described in detail above, each of the assets, such as the assets 111, 112 and 113, can send a request, as illustrated by the communications 251, to the new manager 230, requesting identification information, or, optionally, additional information, about the new manager 230. In response to each of such communications 251, the new manager 230 can, individually, transmit a response providing the requested information, as illustrated by the communications 252. Since the manager was changed from the manager 130 to the new manager 230, upon receiving the communications 252, each of the managed assets 111, 112 and 113 can, individually, compare the manager identifier received via the communications 252 to the manager identifier stored in their tables 121, 122 and 123, respectively, and can determine that the identifiers do not match.

In one embodiment, in such an instance, where an asset receives a manger identifier that differs from the manager identifier it has retained locally, a voting protocol can be utilized to ensure that all of the assets being managed by a manager agree as to which device is acting as their manager. Such a voting protocol can be triggered, as indicated, by one or more of the assets detecting that the manager information received, such as via the communications 252, differs from the manager information currently retained at the asset. For example, an asset making a determination that the most recently received manager identifier differs from the manager identifier which that asset has stored in its table can transmit communications to the other assets initiating a voting protocol. Subsequently, each of the assets can transmit the manager identifier they have locally stored to the manager. Alternatively, rather than sending communications to the other assets, an asset determining that a received manager identifier differs from a locally-stored manager identifier can transmit communications to the manager, requesting that the manager initiate the voting protocol. As yet another alternative, a voting protocol can be triggered by the new manager 230 on its own, such as either as a periodic event, or as part of the updating of the asset management table 240. As to the latter, in one embodiment, if the new manager 230 detects that more than a threshold portion of the asset management table 240 was replaced, or reflects new assets, the new manager 230 can initiate a voting protocol.

The system 200 of FIG. 2 illustrates an exemplary embodiment in which the voting protocol commences with the new manager 230 transmitting, as illustrated by the communications 261, to each managed asset 111, 112 and 113, individually, a request for the identifier that those assets maintain in the tables 121, 122 and 123, respectively. As indicated, the communications 261 can have been triggered by the new manager 230 itself, or by an explicit request from one or more of the assets 111, 112 or 113, such as when they received the communications 252 and determined that the manager identifier provided with the communications 252 differed from the manager identifier that the assets 111, 112 or 113 had stored in their tables 121, 122 and 123, respectively

Irrespective of the manner in which the voting protocol is triggered, the voting protocol can, in one embodiment, comprise the transmission, by each of the assets 111, 112 and 113, to the new manager 230, of the information currently stored in the tables 121, 122 and 123 of those assets. As indicated, such information can comprise an identification of the manager that each of those assets, individually, believes is currently managing them. The transmission of the manager identification, individually, by each of the assets 111, 112 and 113 is illustrated in the system 200 of FIG. 2 by the communications 262.

Upon receiving the communications 262 the new manager 230 can compare the manager identifier from each of the communications 262 to its own identifier to ensure that each of the assets 111, 112 and 113 believes it is being managed by the new manager 230, and has an identification of the new manager 230 stored in their respective tables, namely the tables 121, 122 and 123. Such a comparison is represented by the action 263, shown in the system 200 of FIG. 2. If each of the assets 111, 112 and 113 already has an identification of the new manager 230 stored in their respective tables 121, 122 and 123, as indicated by the communications 262, than the new manager 230 can proceed to manage the assets 111, 112 and 113, such as in accordance with the state-based management referenced above with reference to the periodic communications 151 and 152 of the system 100 of FIG. 1, and which will be described in further detail below. If, however, one or more of the assets 111, 112 and 113 does not have an identification of the new manager 230 stored in their respective tables 121, 122 and 123, as indicated by the communications 262, than the new manager 230 can proceed to take corrective action, such as by directly instructing the relevant ones of the assets 111, 112 and 113 that it is their manager, and providing appropriate manager identifying information. For clarify of graphical illustration, such an explicit instruction, by the new manager 230, to the assets 111, 112 and 113 is not shown in FIG. 1. In response to such an explicit instruction, however, the assets 111, 112 and 113 can update their tables 121, 122 and 123, respectively, as illustrated by the actions 271, 272 and 273, respectively. In such a manner, the above-described voting protocol, can provide for each asset to obtain an updated manager identifier, such as when the manager is changed, while reducing the chances of an asset improperly changing the manager identifier it has locally stored.

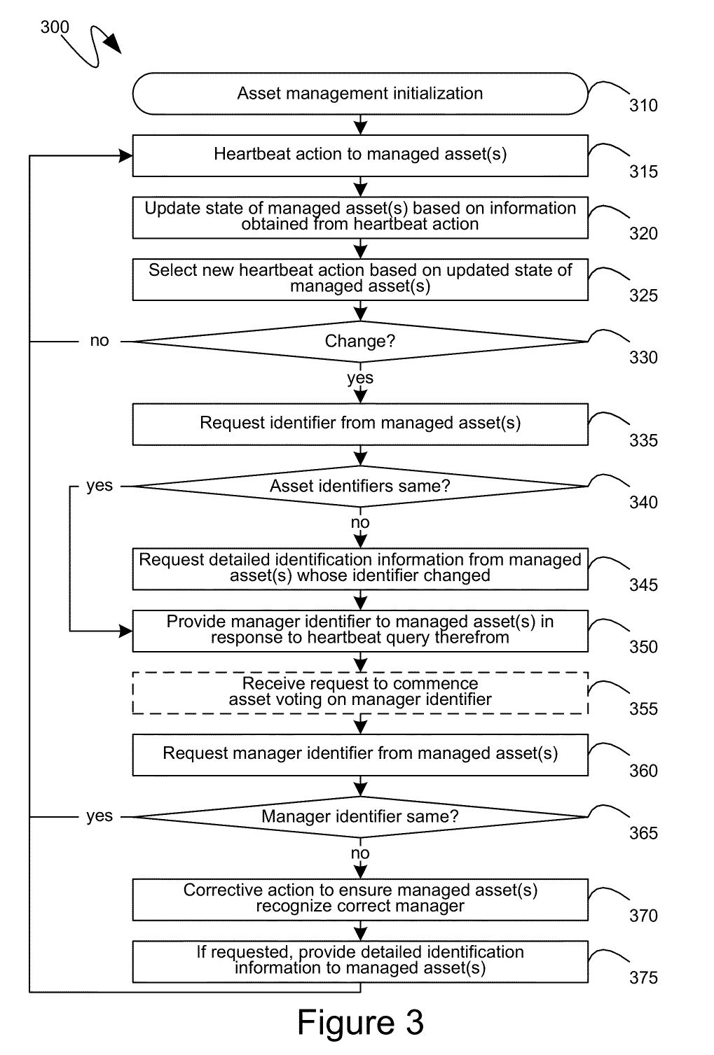

Turning to FIG. 3, the flow diagram 300 shown therein illustrates an exemplary series of steps for implementing a decentralized hardware asset management. In one embodiment, after an initialization step, at step 310, a hardware asset manager can proceed, at step 315, to instruct managed assets to perform an action. As indicated by the “heartbeat” terminology utilized in FIG. 3, the instruction, to the managed assets, at step 315, can be triggered and performed on a periodic basis. The information received from the managed assets, in response to the instruction sent at step 315, can be utilized, at step 320, by the asset manager, to update a state of that asset. A subsequent action, at step 325, can be selected based upon the state of the asset after its potential updating at step 320. If no change is detected to the assets that are being managed, at step 330, then processing can return to the instruction of the managed assets at step 315.

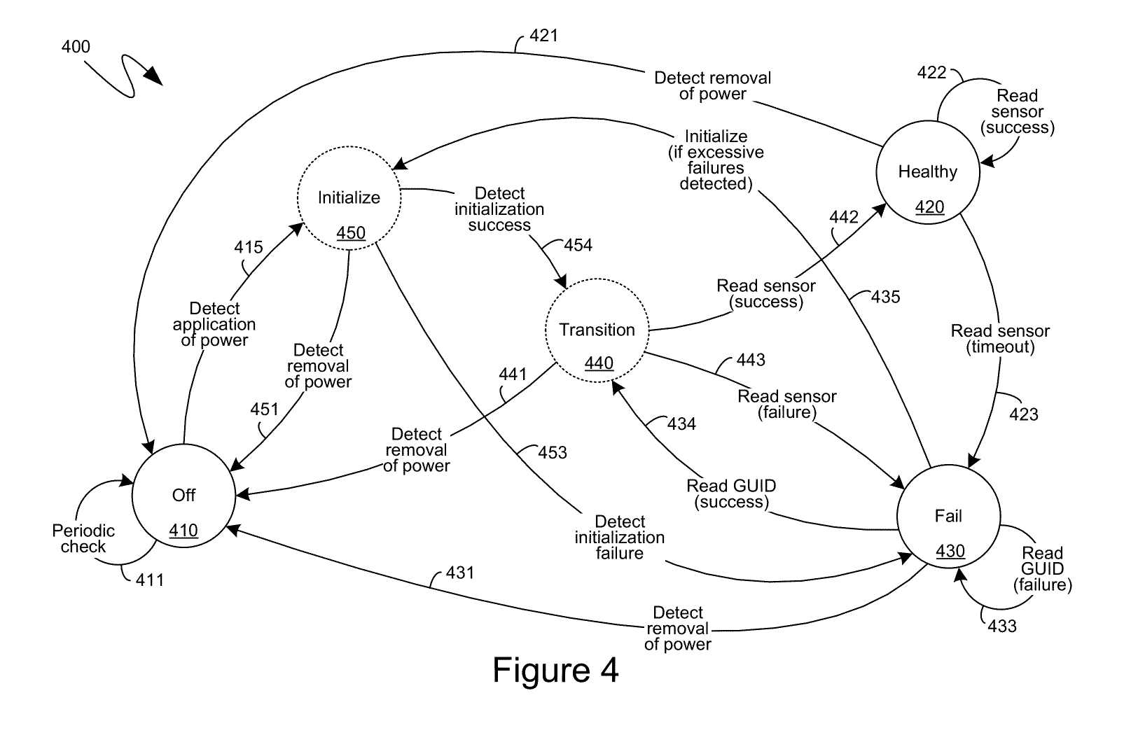

Although described more fully with reference to the state diagram 400 of FIG. 4, as one example, an asset manager can, at step 315, instruct an asset to read a sensor. A response can be received and, continuing this illustrative example, such a response could indicate a timeout error signifying that information was not received from the sensor for a given period of time. At step 320, then, the asset manager can update a state of the managed asset to signify that the managed asset is no longer in a “correctly operating” state, and is, instead, in an “improperly operating” state. At step 325, a subsequent action can be selected for that managed asset based upon its state. Since, in the present example, its state can have changed in the immediately preceding performance of step 320, the selection of a new action, at step 325, can be based on the managed asset being in an “improperly operating” state. For example, the new action selected at step 325 can be an instruction to the managed asset to read something simpler than a sensor, such as, for example, to simply read an identifier stored in some memory location of the managed asset. Upon a subsequent performance of step 315, the action selected at step 325, such as the read identifier action, can be requested of the managed asset and, during a subsequent performance of step 320, the state of the asset can, again, be updated. For example, if the reading of the identifier also fails, then, during such a subsequent performance of step 320, the state of the asset can remain in the “improperly operating” state. Conversely, as another example, if the reading of the identifier succeeds, than the state of the asset can be updated, at step 320, to reflect the state indicated of a success in reading an identifier, but a timeout error in reading a sensor. Such a state can then inform a new action to be selected, during a subsequent performance of step 325, that can, as one example, attempt to read the sensor again to see if the delay has cured itself.

In one embodiment, if a change of the assets that are being managed is detected at step 330, processing can proceed at step 335. For example, as illustrated previously, one such change, which can be detected at step 330, can be a replacement of a managed asset with a new managed asset. Other like changes can also be detected. In response, at step 335, an identifier can be requested from one or more of the managed assets. In one embodiment, rather than conditioning the performance of step 335, and the requesting of an identifier from one or more managed assets, only on the detection of a change of those managed assets, step 335 can, instead, simply be performed periodically irrespective of whether the manager has any input suggestive of a change of the managed assets. In one optimization, a check can be made, such as at step 340, to determine whether the identifiers returned by the managed assets, in response to the request sent at step 335, are the same as the identifiers of the managed assets of which the asset manager is previously aware, such as the identifiers already stored in an asset management table that can be maintained by the asset manager. If such a check, at step 340, is made, and it is determined that the asset identifiers that were returned are the same, at least for some assets, then, in one embodiment, at least for those assets, processing can proceed directly to step 350, and need not perform step 345. Conversely, if, at step 340, it is determined that the asset identifiers of at least some assets are different, such a determination can indicate that those assets changed and, subsequently, at step 345, detailed identification information can be requested from those assets. As indicated previously, such detailed identification information can include an identification of the manufacturer of such assets, the serial number of such assets, the model number of such assets, any installed options that such assets may have, and other like detailed identification information. In other embodiments, rather than performing steps 335, 340 and 345, the detailed identification information requested at step 345 can be performed without first requesting an identifier, such as at step 335.

In addition to obtaining identification information, such as an identifier or the detailed identification information described above, an asset manager can also provide its own identification information to the assets it is managing. Thus, at step 350, the asset manager can provide its own identification information to one or more of the assets it is managing. For example, in one embodiment, at step 350, the asset manager can provide its own identification information only to those one or more assets that the asset manager determined have changed, such as through the execution of steps 330, 335 and 340. In another embodiment, at step 350, the asset manager can provide its own identification information to some or all of the assets it is managing irrespective of whether or not the asset manager has received input suggestive that such assets have changed. In yet another embodiment, the provision of manager identification information to managed assets, such as at step 350, can be in response to an explicit query for such information from one or more of the managed assets. In such an embodiment, assets can periodically request manager identification information, such as is indicated by utilization of the term “heartbeat” in the illustration of FIG. 3. Alternatively, assets can request manager identification information in response to input suggestive that the asset manager has changed. As an optional optimization, although not explicitly illustrated in the flow diagram 300 of FIG. 3, assets can also avoid requesting detailed identification information from an asset manager without first verifying that they do not already comprise such detailed identification information, such as by verifying that an asset manager identifier differs from the identifier of an asset manager whose detailed identification information the assets may already comprise.

While the steps 330 through 355 have been described above in the context of a change of one or more of the assets being managed, another type of change that can be detected, such as at step 330, can be a change of the asset manager itself. More specifically, in one embodiment, when a new asset manager is instantiated, it can proceed directly with step 335 since such a new asset manager may not comprise sufficient information to perform steps 315 through 325 without first performing at least one of steps 335 and 345. Consequently, in such an embodiment, a new asset manager can request identifiers from the assets it is managing, such as at step 335, and can, optionally, request detailed identification information from those assets, such as at step 345. In one embodiment, managed assets and asset managers can be communicationally coupled to one another through dedicated communicational links, such as through serial communication cables, or other like communicational infrastructure. In such an embodiment, a new asset manager can perform step 335, or step 345, if performed directly without first performing steps 335 and 340, by simply broadcasting such a request to all devices communicationally coupled to the same dedicated communicational link as the new asset manager. In such a manner, the asset manager can discover all of the assets that it is to manage, since those assets would be communicationally coupled to the new asset manager, such as through such dedicated, or out of band, communicational infrastructure.

Once a new asset manager has completed steps 335 through 350, described in detail above, it can, optionally, in one embodiment, initiate a voting among the managed assets to ensure that those managed assets correctly recognize the new asset manager as their asset manager. For example, as described above, upon receiving the manager identifier that the manager transmitted at step 350, one or more of the assets can detect that such a manager identifier differs from the manager identifier that such an asset has stored. In response, those one or more assets can request that the manager initiate a voting protocol. Such a request can be received at step 355. In response, the manager can request the manager identifier from the assets it is managing, such as is illustrated by step 360. In another embodiment, the voting can be initiated by the new asset manager itself, such as by directly performing step 360, without receiving a request at step 355. Consequently, to illustrate that step 355 is optional, it is shown in FIG. 3 in dashed lines.

Irrespective of the manner in which voting is triggered, in one embodiment, as part of the voting, each of the assets can transmit, to the new asset manager, an identifier of the asset manager that those assets believe is managing them, namely the asset manager identifier that those assets have stored locally. At step 365, the asset manager can compare the asset manager identifier received from one or more of the assets with its own identifier to verify that those assets recognize the new asset manager as their asset manager. If the identifiers are the same, then the assets do recognize the new asset manager as their asset manager, and processing can proceed with the management of those assets, such as in the manner represented by steps 315 through 325, described in detail above, and shown in the exemplary flow diagram 300 of FIG. 3. Conversely, if, at step 365 the asset manager determines that one or more assets have identified an asset manager that is not the new asset manager, then corrective action can be taken at step 370 to ensure that those assets properly recognize the new asset manager as their asset manager, such as by instructing those assets to store an identifier of the new asset manager and, thereby, recognize it as their asset manager. If requested by one or more of the assets, such as in response to the corrective action at step 370, the manager can provide, at step 375, to those requesting assets, further detailed identification information, such as the detailed identification information enumerated above. Processing can then proceed with the management of assets, such as in the manner represented by steps 315 through 325.

Turning to FIG. 4, an exemplary state diagram 400 is shown therein, illustrating an exemplary sequence of states that an asset manager can assign to an asset, and further illustrating how the maintenance of, and knowledge of, such states can inform a subsequent management action taken by the asset manager with regard to the asset and can optimize the operation of the asset manager and the overall asset management system. The exemplary state diagram 400, shown in FIG. 4, comprises five states, an off state 410, a healthy state 420, a failed state 430, a transition state 440 and an initialize state 450. As will be recognized by those skilled in the art, such states are merely exemplary, and an asset manager can identify assets as being in any one of any number of states that the asset manager can select as being appropriate states for such assets, given such assets' capabilities and functionality. For example, in the exemplary state diagram 400 of FIG. 4, the transition state 440 and the initialize state 450 can be states that can be particular to a specific type of asset, and can be states that are transitory, or temporary. To illustrate their transitory nature, the transition state 440 and the initialize state 450 are illustrated in the state diagram 400 of FIG. 4 with dashed lines. At a minimum, however, it is likely that most assets will at least have a “powered on” state and a “powered off” or “unavailable” state. In some assets, the “powered on” state can be further divided into a “properly operating” state and an “improperly operating” state. As illustrated by states 440 and 450, other states, including intermediate states, and transitory states, can also be defined and utilized, in accordance with the type of asset being managed, and its capabilities and functionalities.

Turning to the exemplary state diagram 400 shown in FIG. 4, a managed asset can, initially, be in a powered off state 410. An appropriate action that an asset manager can perform for an asset in such a state can be the periodic check 411 to determine whether the assets remains in the powered off state 410. As illustrated, the performance of such a periodic check 411 is informed by the state that such an asset is in, namely, the powered off state 410. For an asset in the powered off state 410, an asset manager can also detect the application of power to such an asset. In response to a detection of an application of power, such as is graphically illustrated by the detection of the application of power 415, the state that the asset is in can be changed, by the asset manager, from the powered off state 410 to the initialize state 450. In one embodiment, knowledge that an asset is in the powered off state 410 can enable an asset manager to avoid performing certain tasks and transmitting certain communications to such an asset. For example, for an asset in the powered off state 410, a manager can perform the periodic check 411 less frequently than others of the periodic actions performed when an asset is in an operational state. Such avoidance of the performance of actions, or the selection to perform actions tailored to a particular asset state, enables the asset manager to increase its efficiency and optimize its performance.

If, through, one of the period checks, the asset manager detects the application of power 415, then, in one embodiment, the asset can be transitioned to an initialize state 450. Such an initialize state 450 can represent a temporary, or transitory, state that more complex assets, such as servers, can transition through, and which can be appropriate for such assets. Other assets, such as fans, may not need to be associated with an initialize state and can, instead, transition directly from a powered off state to one of the powered on states, such as the healthy state 420 which will be described in detail below. If an asset is in the initialize state 450, an asset manager can detect either a removal of power 451, an initialization failure 453 or an initialization success 454. If the asset is powered off, or loses power, while it is still in the initialize state 450, the asset manager can detect a removal of power 451 and can change the state of the asset from the initialize state 450 to the powered off state 410. As will be understood by those skilled in the art, the detection of the removal of power 451, by the asset manager, can be based on periodic checking of the asset, or through continuous monitoring thereof. Irrespectively, the existence of the asset in the initialize state 450 can inform the behavior of the asset manager with respect to that state, namely that the asset manager can continue to monitor the state such as to, for example, detect the removal of power 451, or to detect other events, such as an initialization failure 453, or initialization success 454. Additionally, knowledge that the asset is in the initialize state 450 can enable the asset manager to optimize its performance. For example, the above-referenced monitoring can occur at a reduced frequency. Additionally, as another performance optimization, the asset manager can avoid transmitting instructions or queries to an asset, which the asset manager has associated with the initialize state 450, that are incompatible with an asset in such a state. In such a manner, the asset manager can optimize its performance. As illustrated in the exemplary state diagram 400 of FIG. 4, if the asset manager detects an initialization failure 453, the asset manager can change the state of the asset from the initialize state 450 to the fail state 430. Similarly, if the asset manager detects an initialization success 454, in one embodiment, the asset manager can change the state of the asset from the initialize state 450 to another transitory state, such as the transition state 440.

As in the case of the initialize state 450, the transition state 440 can, in one embodiment, represent a temporary state through which more complex assets, such as servers, can transition through, which can be appropriate for such assets. For example, a transition state can represent a state after an asset has properly initialized, but before the asset manager has verified proper operation of the asset. Thus, for example, from the transition state 440, an asset manager can cause the assets to perform an operation, such as to read a sensor, and such a successful sensor read 442 can cause the asset manager to transition the asset from the transition state 440 to the healthy state 420. As before, the state of the asset can inform the action taken by the asset manager with respect to such asset. For example, the asset manager can attempt to read sensors of assets that are in the transition state 440. In such an example, the existence of the asset in the transition state 440 informs the action of the asset manager, namely the attempting of the sensor read. Additionally, in such an example, the existence of the asset in the transition state 440 can enable the asset manager to optimize its operation, such as by only attempting the sensor read, or changing the manner in which such a sensor read is performed to avoid inefficiencies. Should the read sensor operation not be successful, such a read sensor failure 443 can cause the asset manager to transition the asset from the transition state 440 to a fail state 430. Another action that can be undertaken by the asset manager with respect to an asset in the transition state 440 can be to monitor the asset to determine whether the asset still has power. If the asset manager detects a removal of power 441, it can change the asset from the transition state 440, back to the powered off state 410.

An asset in the healthy state 420 can be performing properly and can be managed properly by the asset manager. In one embodiment, such a proper performance and management can entail the reading of sensors of the asset. For example, simple assets, such as fans, can comprise sensors that can report fan speed, power consumption, temperature, and other like metrics. More complex assets, such as, for example, server computing devices, can comprise a myriad of other sensors including temperature sensors, various component sensors, such as hard disk drive sensors, and other like detection mechanisms. An asset can be maintained in the healthy state 420 if the reading of sensors, such as by the asset manager, are successful. Thus, as illustrated by the exemplary state diagram 400 of FIG. 4, a read sensor success 422 can maintain an asset in the healthy state 420. As before, the state of the asset can inform the actions taken by the asset manager with respect to such an asset. Thus, for example, for assets in the healthy state 420, the existence of those assets in such a state can cause the asset manager to continue to attempt to read sensors from such assets. If such a reading of an asset fails, on the other hand, the asset can be transitioned, by the asset manager, from the healthy state 420 to a fail state 430, as illustrated by the sensor read timeout 423 in the state diagram 400. In addition, as described previously, the asset manager can continue to monitor assets in the healthy state 420 to detect a removal of power 421. Should such a removal of power 421 be detected, the asset manager can transition the asset back to the powered off state 410.

In one embodiment, a failure state, such as the fail state 430, can entail a state in which an asset may have failed one or more tasks, but may otherwise be operating properly. For example, the failure to read a sensor can cause an asset to be assigned the fail state 430. As will be recognized by those skilled in the art, however, sensor failures can often occur due to timeout conditions, where the sensor may be operating, but the asset cannot read such a sensor within an allocated amount of time. As will also be recognized by those skilled in the art, such conditions can often be temporary, and can be due to a particular set of circumstances, that may resolve itself, such as without further action on the part of the asset manager. Consequently, in one embodiment, for assets classified in the fail state 430, the asset manager can attempt to perform a simpler operation such as, for example, the reading of an identifier. If the reading of an identifier is successful, the asset manager can transition the asset from the fail state 430 to the transition state 440, as illustrated by the successful reading of the identifier 434 in the state diagram 400. In the transition state 440, the asset manager can then, again, attempt to read the sensor and, if such a reading is successful, the asset can be transitioned back to the healthy state 420 as illustrated by the successful sensor read 442, which was described previously. Conversely, if the re-attempted reading of the sensor is not successful, the asset can be transitioned back to the fail state 430, as illustrated by the sensor read failure 443, which was also described previously.

If the reading of an identifier is, itself, unsuccessful, than the failed sensor read 433 can cause the assets to be maintained in the fail state 430. In one embodiment, after an excessive number of such failures are detected, the asset manager can instruct the asset to initialize 435, which can transition the asset back to the initialize state 450, which was described in detail above. Again, as before, the existence of an asset in the fail state 430, coupled with the detection of an excessive quantity of failures, can inform the actions of the asset manager with respect to such an asset, namely it can cause the asset manager, in the present example, to initialize 435 the asset. As before, the asset manager can continue to monitor assets for the removal of power 431, including for assets in the failed state 430. Should such a removal of power 431 be detected, the asset manager can transition the asset back to the powered off state 410.

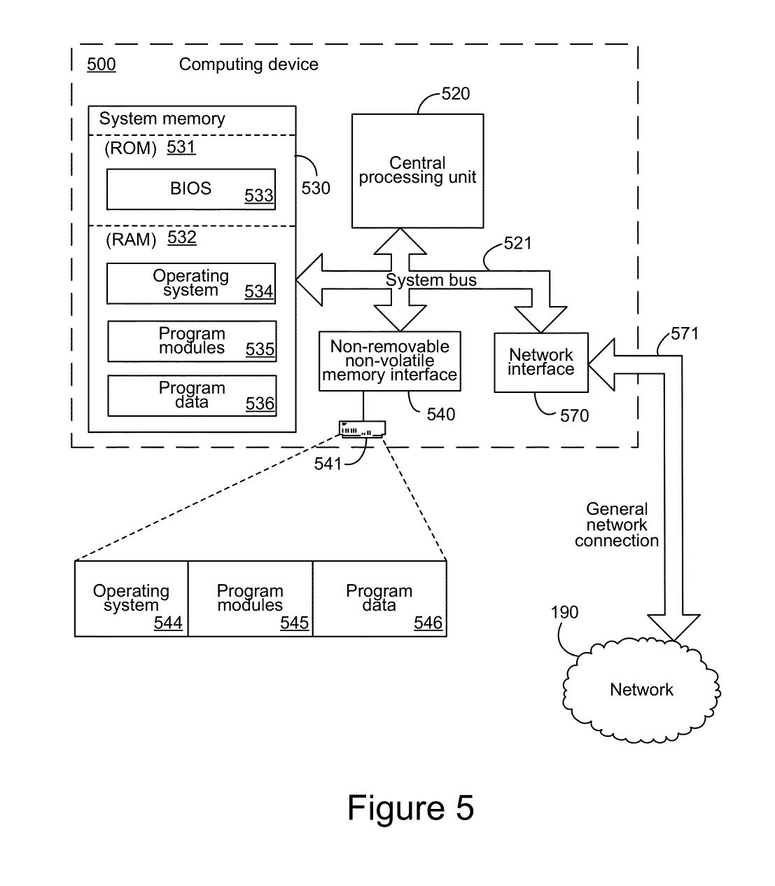

Turning to FIG. 5, an exemplary computing device 500 is illustrated, comprising, in part, hardware elements that can be utilized in performing and implementing the above described mechanisms. The exemplary computing device 500 can include, but is not limited to, one or more central processing units (CPUs) 520, a system memory 530 and a system bus 521 that couples various system components including the system memory to the processing unit 520. The system bus 521 may be any of several types of bus structures including a memory bus or memory controller, a peripheral bus, and a local bus using any of a variety of bus architectures. Depending on the specific physical implementation, one or more of the CPUs 520, the system memory 530 and other components of the computing device 500 can be physically co-located, such as on a single chip. In such a case, some or all of the system bus 521 can be nothing more than silicon pathways within a single chip structure and its illustration in FIG. 5 can be nothing more than notational convenience for the purpose of illustration.

The computing device 500 also typically includes computer readable media, which can include any available media that can be accessed by computing device 500. By way of example, and not limitation, computer readable media may comprise computer storage media and communication media. Computer storage media includes media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 500. Computer storage media, however, does not include communication media. Communication media typically embodies computer readable instructions, data structures, program modules or other data in a modulated data signal such as a carrier wave or other transport mechanism and includes any information delivery media. By way of example, and not limitation, communication media includes wired media such as a wired network or direct-wired connection, and wireless media such as acoustic, RF, infrared and other wireless media. Combinations of the any of the above should also be included within the scope of computer readable media.

When using communication media, the computing device 500 may operate in a networked environment via logical connections to one or more remote computers. The logical connection depicted in FIG. 5 is a general network connection 571 to the network 190 described previously. The network 190 to which the exemplary computing device 500 is communicationally coupled can be a local area network (LAN), a wide area network (WAN) such as the Internet, or other networks. The computing device 500 is connected to the general network connection 571 through a network interface or adapter 570, which is, in turn, connected to the system bus 521. In a networked environment, program modules depicted relative to the computing device 500, or portions or peripherals thereof, may be stored in the memory of one or more other computing devices that are communicatively coupled to the computing device 500 through the general network connection 571. It will be appreciated that the network connections shown are exemplary and other means of establishing a communications link between computing devices may be used.

Among computer storage media, the system memory 530 comprises computer storage media in the form of volatile and/or nonvolatile memory, including Read Only Memory (ROM) 531 and Random Access Memory (RAM) 532. A Basic Input/Output System 533 (BIOS), containing, among other things, code for booting the computing device 500, is typically stored in ROM 531. RAM 532 typically contains data and/or program modules that are immediately accessible to and/or presently being operated on by processing unit 520. By way of example, and not limitation, FIG. 5 illustrates operating system 534, other program modules 535, and program data 536.

The computing device 500 may also include other removable/non-removable, volatile/nonvolatile computer storage media. By way of example only, FIG. 5 illustrates a hard disk drive 541 that reads from or writes to non-removable, nonvolatile media. Other removable/non-removable, volatile/nonvolatile computer storage media that can be used with the exemplary computing device include, but are not limited to, magnetic tape cassettes, flash memory cards, digital versatile disks, digital video tape, solid state RAM, solid state ROM, and the like. The hard disk drive 541 is typically connected to the system bus 521 through a non-removable memory interface such as interface 540.

The drives and their associated computer storage media discussed above and illustrated in FIG. 5, provide storage of computer readable instructions, data structures, program modules and other data for the computing device 500. In FIG. 5, for example, hard disk drive 541 is illustrated as storing operating system 544, other program modules 545, and program data 546. These components can either be the same as or different from operating system 534, other program modules 535 and program data 536. Operating system 544, other program modules 545 and program data 546 are given different numbers here to illustrate that, at a minimum, they are different copies.

As can be seen from the above descriptions, decentralized hardware asset management has been presented. In view of the many possible variations of the subject matter described herein, we claim as our invention all such embodiments as may come within the scope of the following claims and equivalents thereto.

We claim:

1. One or more computer-readable media comprising computer-executable instructions for managing hardware assets, the computer-executable instructions directed to steps comprising:
requesting identification information from a hardware asset;
storing the hardware asset's identification information in an asset management table comprising identification information of one or more hardware assets being managed, wherein the one or more hardware assets being managed comprise the hardware asset;
maintaining state information of the hardware asset, the maintained state information representing an operational state of the hardware asset;
optimizing performance based upon the maintained state information of the hardware asset, the optimizing performance comprising tuning communications to the hardware asset in accordance with the maintained state information of the hardware asset; and
updating the maintained state information of the hardware asset based upon zero or more responses received from the hardware asset in response to a transmission of the determined communication thereto.

2. The computer-readable media of claim 1, comprising further computer-executable instructions for requesting detailed identification information from the hardware asset if the hardware asset's identification information differs from that stored the asset management table; the detailed identification information comprising at least one of a manufacturer information, a model number information, or a version number information.

3. The computer-readable media of claim 1, comprising further computer-executable instructions for providing, to the hardware asset, an identifier of a computing device executing the computer-executable instructions.

4. The computer-readable media of claim 3, wherein the providing the identifier of the computing device executing the computer-executable instructions to the hardware asset is performed in response to an explicit request, from the hardware asset, for the identifier of the computing device executing the computer-executable instructions.

5. The computer-readable media of claim 1, comprising further computer-executable instructions for implementing a voting protocol among at least some of the hardware assets being managed, the further computer-executable instructions directed to steps comprising:
receiving, from multiple ones of the hardware assets being managed, an identifier of a manager that each of the multiple ones of the hardware assets being managed had retained in its local storage;
identifying any of the multiple ones of the hardware assets being managed from whom the received identifier of the manager differed from an identifier of a computing device executing the computer-executable instructions; and
instructing the identified hardware assets being managed to replace the received identifier of the manager with the identifier of the computing device executing the computer-executable instructions.

6. The computer-readable media of claim 5, comprising further computer-executable instructions for receiving, from the hardware asset, a request to perform the voting protocol; wherein the further computer-executable instructions for implementing the voting protocol are executed in response to receiving the request from the hardware asset to perform the voting protocol.

7. The computer-readable media of claim 1, wherein the computer-executable instructions for optimizing performance based upon the maintained state of the hardware asset comprise computer-executable instructions for tuning the communications to the hardware asset so as to transmit a request for the hardware asset to read a sensor.

8. The computer-readable media of claim 1, wherein the computer-executable instructions for optimizing performance based upon the maintained state of the hardware asset comprise computer-executable instructions for tuning the communications to the hardware asset so as to transmit a check of whether the hardware asset is receiving electrical power.

9. A hardware device performing steps comprising:
receiving a manager device identifier from a manager device managing the hardware device;
comparing the received manager device identifier to a previously stored manager device identifier; and
requesting, if the received manager device identifier differs from the previously stored manager device identifier, an initiation of a voting protocol among other hardware devices managed by the manager device that is associated with the received manager device identifier.

10. The hardware device of claim 9, performing further steps comprising receiving, from the manager device, in response to the requesting, a request for a currently stored manager device identifier; wherein the requesting comprises requesting the manager device to initiate the voting protocol.

11. The hardware device of claim 9, performing further steps comprising storing, at the hardware device, the manager device identifier.

12. The hardware device of claim 11, wherein the voting protocol results in the storing the manager device identifier at the hardware device; and wherein further the storing the manager device identifier at the hardware device is only performed within the context of the voting protocol.

13. The hardware device of claim 9, performing further steps comprising periodically requesting the manager device identifier from the manager device.

14. A system comprising:
a hardware device performing steps comprising:
receiving a manager device identifier from a manager device managing the hardware device;
comparing the received manager device identifier to a previously stored manager device identifier; and
requesting, if the received manager device identifier differs from the previously stored manager device identifier, an initiation of a voting protocol among other hardware devices managed by the manager device; and
the manager device, the manager device comprising one or more computer-readable media, the one or more computer-readable media comprising computer-executable instructions directed to steps comprising:
requesting identification information from the hardware device;
storing the hardware device's identification information in an asset management table;
maintaining state information of the hardware device, the maintained state information representing an operational state of the hardware device;
optimizing performance based upon the maintained state information of the hardware device, the optimizing performance comprising tuning communications to the hardware asset in accordance with the maintained state information of the hardware asset; and
updating the maintained state information of the hardware device based upon zero or more responses received from the hardware device in response to a transmission of the determined communication thereto.

15. The system of claim 14, wherein the hardware device performs further steps comprising storing, at the hardware device, the manager device identifier.

16. The system of claim 15, wherein the voting protocol results in the storing the manager device identifier at the hardware device; and wherein further the storing the manager device identifier at the hardware device is only performed within the context of the voting protocol.

17. The system of claim 14, further comprising a second hardware device, the second hardware device also being managed by the manager device;
wherein the one or more computer-readable media of the manager device further comprise computer-executable instructions for implementing a voting protocol among at least the hardware device and the second hardware device, steps comprising:
receiving, from each of the hardware device and the second hardware device, an identifier of a manager that each of the hardware device and the second hardware device had retained in their local storage; and
determining if any of the identifiers received from the hardware device or the second hardware device differ from the manager device identifier.

18. The system of claim 14, wherein the one or more computer-readable media of the manager device further comprise computer-executable instructions for requesting detailed identification information from the hardware device if the hardware device's identification information differs from that stored the asset management table; the detailed identification information comprising at least one of a manufacturer information, a model number information, or a version number information.

19. The system of claim 14, wherein the computer-executable instructions for optimizing performance based upon the maintained state of the hardware device comprise computer-executable instructions for tuning the communications to the hardware asset so as to transmit a request for the hardware device to read a sensor.

20. The system of claim 14, wherein the computer-executable instructions for optimizing performance based upon the maintained state of the hardware device comprise computer-executable instructions for tuning the communications to the hardware asset so as to transmit a check of whether the hardware device is receiving electrical power.
